(19) United States
(12) Patent Application Publication
(10) Pub. No.: US 2016/0335324 A1
(43) Pub. Date: Nov. 17, 2016

(54) Geographic Application Partitioning

(71) Applicant: Jesse M Caulfield, McLean, VA (US)

(72) Inventor: Jesse M Caulfield, McLean, VA (US)

(21) Appl. No.: 14/709,795

(22) Filed: May 12, 2015

(51) Int. Cl. G06F 17/30

(52) U.S. Cl. CPC G06F 17/30486; G06F 17/30241

(57) ABSTRACT

A method is provided to partition and distribute application processing across a plurality of nodes wherein the selection of a node is made according to that node's geographic area of responsibility. In a client/server environment application processing requests are received by a primary application node and may be routed or forwarded to one or more partitioned application nodes according to request location information and a partitioning assignments database.

### CROSS-REFERENCE TO RELATED APPLICATIONS

Not Applicable.

### FIELD OF THE INVENTION

The present invention relates to distributed computer-based application processing wherein the selection of a application processing node is made according to a geographic area of responsibility.

### BACKGROUND OF THE INVENTION

In a client/server communications environment one method of increasing server capacity is to add multiple servers and to operate them in parallel. Load balancing strategies may then be implemented to distribute total workload across an inventory of available servers which may increase the aggregate system capacity to deliver services. For example, if a single server may be expected to support ten simultaneous client transactions, two servers operating in parallel may be expected to support 20 simultaneous client transactions, thus increasing total system capacity from 10 to 20.

Within a database system the data may be partitioned and distributed among multiple physical data stores. This process is often referred to as “partitioning” and also “sharding”. Partitioning a database produces a plurality of subsets of the database information. For example, in a relational database management system the data is organized into tables containing rows and columns where each row corresponds to an instance of a data item and each column corresponds to an attribute for the data item. A single database table may be partitioned into a plurality of smaller shards which may then be distributed among a plurality of different physical data stores or servers. This process can provide significantly improved system performance and scalability.

In a client-server system a server application's total functionality may in fact be the aggregate functionality of various sub-systems or application components. Each of those sub-systems or components may be differentially configured to provide a server's response to a client query. This process is often referred to as “distributed computing”.

### Load Balancing Schemes

Load balancing schemes typically incorporate a policy and implementation method. Policy may include decision-making parameters to inform implementation, which describes the actual distribution of load and collection of information required by a policy. Known policies may include participation, location and candidate selection while known implementations may include, for example, transfer and forwarding.

A participation policy may be statically defined by configuration or dynamically evaluated based upon service characteristics, for example. A location policy selects participating servers and is responsible for managing the homogeneity or heterogeneity of the participants. A candidate selection policy selects the tasks, jobs, processes, objects, or whatever the workload unit is, to be distributed. A transfer or forwarding method exchanges and assigns tasks, jobs or processes to or among and between servers, allowing servers to shift tasks to other servers.

### Database Partitioning Schemes

There are many different database partitioning strategies. The most popular include vertical, range-based and key or hash-based partitioning.

Vertical partitioning segments a database by moving tables related to specific features of an application to a different server. For example, user profile information may be stored in one database server with user data in another. Range based partitioning segments a database by assigning records to a sharded instance according to the value range of a record field. An example of range-based partitioning is splitting sales transactions by the year they were created. In a key or hash based partitioning strategy a hash function calculates a index based upon the content of each record to determine on which database server the record is stored.

### Distributed Computing Schemes

Distributed computing is a application processing strategy. Early distributed computing schemes are known to employ a plurality of computer systems physically distributed across a network and possibly some geographic area. Distributed computing schemes are also known in a more general sense where identical autonomous applications processes are executed on a plurality of processing nodes and the various autonomous processes communicate with each other by message passing. Distributed processing is commonly implemented for very large data sets, where the data is segmented into smaller chunks and each smaller chunk is assigned to a processing node.

### BRIEF SUMMARY OF THE INVENTION

The technology described herein relates to the assignment of a application processing request to a partitioned application node according to the geographic area of responsibility of the respective node.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the disclosure.

FIG. 1 is an exemplary block diagram of an application whose functionality has been partitioned across various application nodes that each are registered in a partitioning assignments database.

FIG. 2 depicts an example flow chart that describes a client/server processing transaction according to a geographic application partitioning strategy.

FIG. 3 depicts how various geographical areas of responsibility may be assigned to a corresponding set of partitioned application nodes and optionally to a respective set of application node configurations. FIG. 3 also depicts how request location information may be compared with the various geographical areas of responsibility.

FIG. 4 illustrates an exemplary application partitioning strategy where the various geographic areas of responsibility are assigned according to United States state boundaries.

### DETAILED DESCRIPTION OF A PREFERRED EMBODIMENT

The invention described herein relates to server load-balancing by geographically partitioning an application, including aspects of that application's functionality or specific variances of that application's configuration, across a multitude of processing nodes and then directing application processing to a node based upon that node's geographic area of responsibility.

A node may be instantiated as a actual physical computer server, a virtual machine, a concurrent thread, etc.

As will be demonstrated by the various provided examples, certain applications may benefit from or require a load balancing location, policy and candidate selection strategy that is aware of and accommodates an application's inherent dependency upon regional geographic information. In this instance a benefit exists to implement geographic partitioning of the application. In other instances an application may require a configuration variance based upon a specific geographic area of responsibility, where a benefit exists to implement geographic partitioning of the application and also its configuration.

The disclosure and various features and advantageous details thereof are explained more fully with reference to the exemplary embodiments illustrated in the accompanying drawings and detailed in the following description. Descriptions of known programming techniques, computer software, hardware, operating platforms and protocols may be omitted so as not to unnecessarily obscure the disclosure in detail. The detailed description and the specific examples, while indicating the preferred embodiments, are given by way of illustration only and not by way of limitation. Various substitutions, modifications, additions and/or rearrangements within the spirit and/or scope of the underlying invention will become apparent to those skilled in the art from this disclosure.

The provided examples are furthermore not intended as restrictions or limits to terms with which they are utilized. Instead the examples or illustrations are intended to describe a particular embodiment for illustrative purposes. Those of ordinary skill in the art will appreciate how the provided examples or illustrations encompass other embodiments and such embodiments are intended to be included within the scope of this invention.

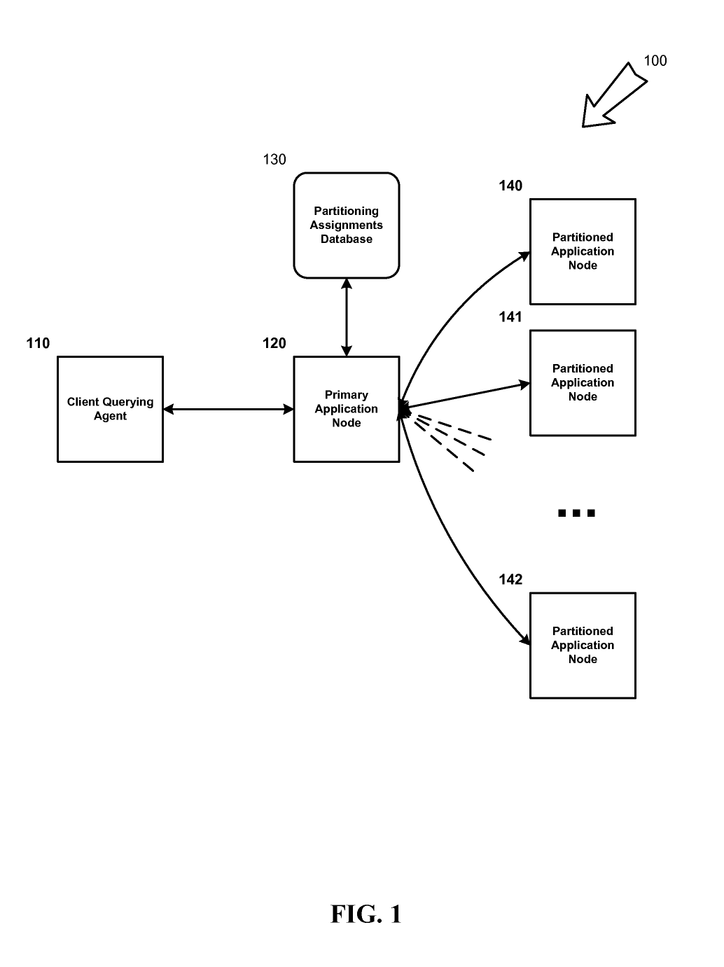

FIG. 1 is an exemplary embodiment of an application whose functionality has been partitioned across various application nodes. The system and method 100 may be implemented in machine-accessible and readable mediums and may incorporate one or more primary application nodes 120 that provide an application processing service to a client querying agent 110. A client querying agent 110 may be any form of client software, such as, for example, a web browser or other component of an enterprise application, and may receive manual or automated access to the partitioned application.

In a preferred embodiment a application processing request is initiated by the client querying agent 110 to the primary application server 120. A query/response transaction may not be required however, as in certain enterprise applications; for example, a application process may be initiated according to a configured schedule.

In one envisioned configuration all application nodes 120, 140, 141, 142, etc. may be equivalently configured to accommodate and respond to a processing request. In another envisioned configuration the various applications nodes may be configured to execute a processing functionality that may be unique to a geographic region or area. In both specific examples, a primary application node 120 implements a geographic (location plus policy) load balancing and distributed computing strategy by routing or forwarding a processing task to a partitioned application node 140, 141, 142, etc. for handling according to a geographic assignment strategy established within a partitioning assignments database 130.

In an envisioned implementation a client querying agent 110 request is submitted to a primary application node 120 and routed to a partitioned application node 141, 142, 143; the partitioned application node processes the request and returns an intermediate response to the primary application node 120; and the primary application node incorporates the intermediate response information into a final response to the client querying agent 110.

One possible example of such a routing-type configuration could be a sales tax calculating application in which the primary application node 120 may be configured to calculate a state sales tax while a partitioned application node 141 may be configured to calculate a city sales tax; the primary application node 120 could then incorporate the partitioned application node's intermediate response sales tax value to provide the client querying agent 110 with a total sales tax value in the final response.

In another envisioned implementation example the client query agent 110 request is forwarded to one or more partitioned application nodes 140, 141, 142, etc. and the one or more receiving application nodes may forward a final response directly to the querying agent, the primary application node taking no further part in the client/server transaction. One possible example of such a forwarding-type strategy could be the partitioning of an application to comply with data handling requirements of a regional jurisdiction; a forwarding-type configuration may accommodate application configurations necessary to handle a application user's data according to the present location or nationality of the user.

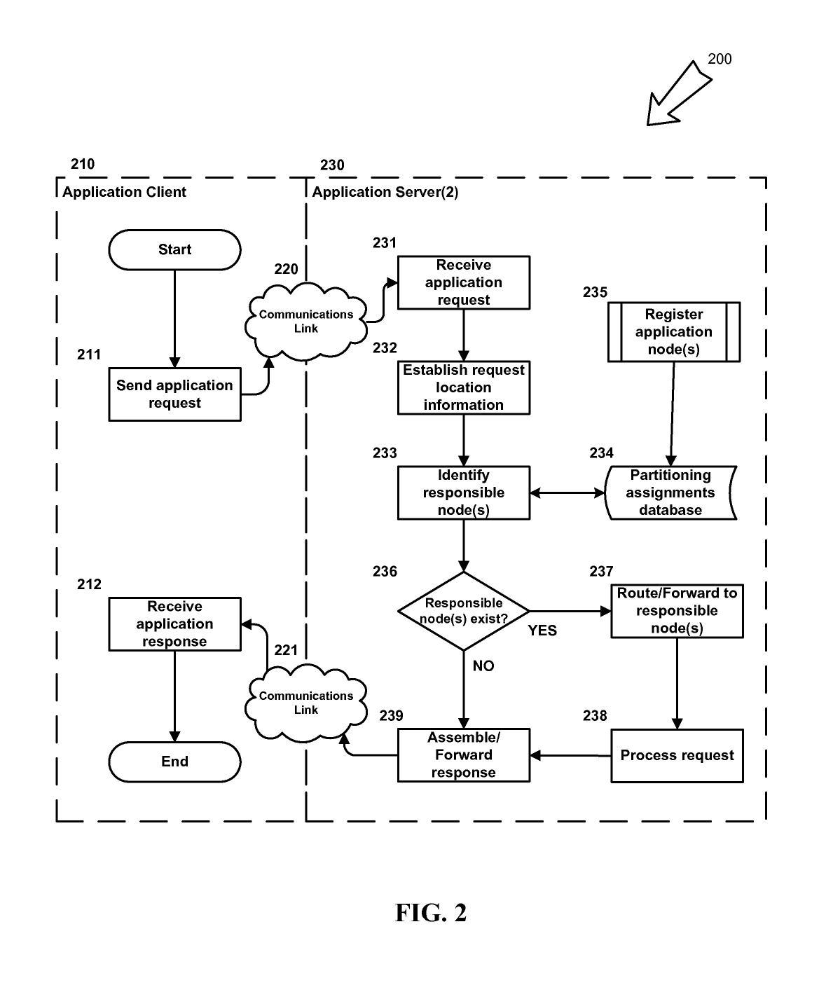

FIG. 2 illustrates an example system and process describing how a geographically partitioned application may implement a strategy to receive, route or forward, process and respond to a application processing request. The process 200 may be implemented in machine-accessible and readable mediums and may incorporate one or more communications links 220, 221 on a network (e.g., for example, but not limited to, the Internet.) The communications links may be wireless, hardwired, or combinations of wireless and hardwired, and directly or indirectly connected. The process 200 includes: from a application client 210 sending an application request 211 to a server system 230 that receives the application request 231 and establish a request location information 232.

The request location information may be directly embedded within the request, such as, for example, a data field containing a geographic coordinate, or may be derived from the request, such as, for example, inferring the application client's geographic coordinates according to an external geographic information system service. No constraint is imposed or implied on the request location information: it may be a simple point coordinate, a polygonal area, or any other geographic geometry as may be considered useful.

Once the request location information is established it may be used to query 233 a partitioning assignments database 234 into which one or more application nodes may have been previously registered via an external process 235. If one or more responsible application nodes exists 236 and are identified by the partitioning assignments database 234 the primary application node may then route or forward 237 the application request to the identified partitioned application nodes for processing 238.

If no responsible application nodes are identified by the partitioning assignments database 234 the primary application node may route or forward the request to itself 237 and immediately process the request 238. Optionally, if no responsible application node is identified, the primary application node may instead abandon the request without responding, a logic flow that is inferred but not illustrated in 200.

After processing 238 a response message may be generated 239 and returned to the client system 210, which may receive the application response 212 and continue its own functionality.

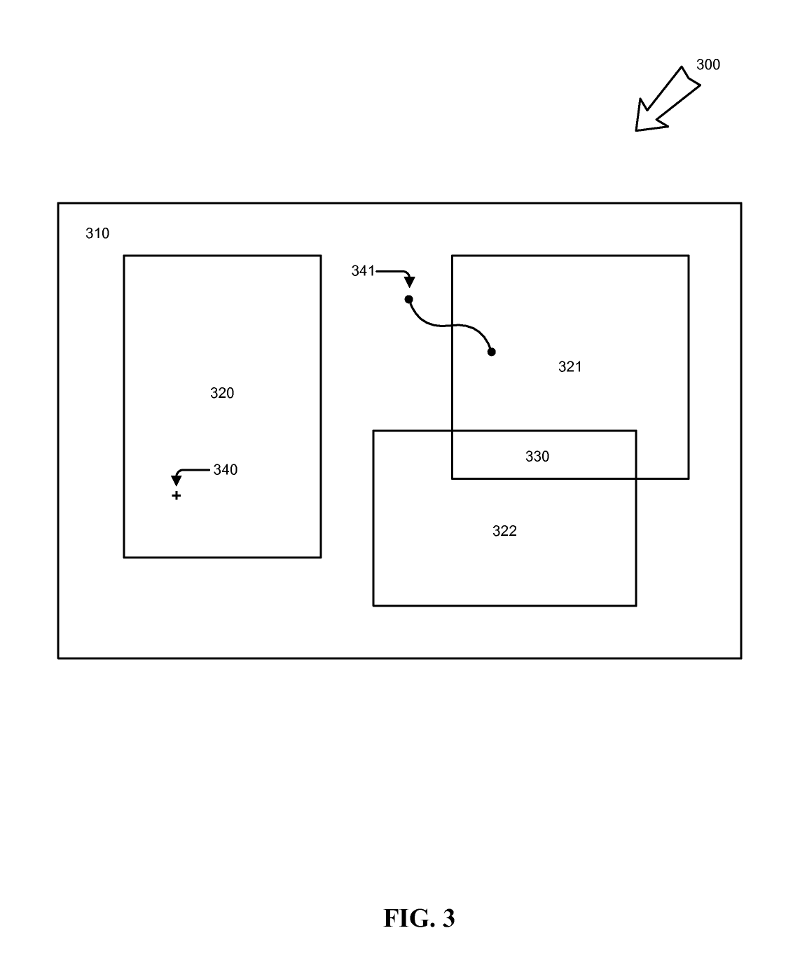

FIG. 3 illustrates an example geographic partitioning strategy. The method 300 may be implemented by performing various geometric calculations using geometries in a partitioning assignments database 234 and request location information.

Various exemplary request location and assignment geometries are also shown in 300 to illustrate possible geometric calculation strategies that may be used for application node selection. For example, a specific point coordinate 340 may be contained within two geometries 310 and 320 but not within two other geometries 321, 322. In another example a linestring geometry 341 may be contained within the geometry 310 and also intersect but not be contained by another geometry 321. In the specific example, application responsibility could be readily determined by evaluating whether the request location geometry is contained or intersected by a geometric area of responsibility or also according to some other geometric principal.

A partitioning method 300 may be implemented by describing a global geometry 310 and various, more specific geometric regions 320, 321 and 322. In an example configuration a primary application node 120 may be assigned responsibility for a global geometry 310 and the various partitioned application nodes 140, 141, 142, etc. assigned responsibility for more specific regions 320, 321, 322 respectively. In the provided example the global geometry 310 is assigned to the primary application node 120 but could just as easily be configured to any other partitioned application node. It is also possible to not define a global geometry 310 in which case a client query request not matching a specific geometry 320, 321, 322 could be optionally handled by the primary application node or discarded or handled as an invalid or unsupported query, for example.

FIG. 3 is purposefully general as, while preferred embodiments of the invention may employ geographic features such as political boundaries, national borders, states, counties, census tracts, etc., the actual method of geographic partitioning 300 is independent of the selected geographic feature class and any geographic geometry representation may be employed.

In the event that two defined geometries overlap 230 a tie-breaking algorithm may be required. In one envisioned embodiment both partitioned application nodes 141, 142 declare responsibility for the regions 321, 322 and the intersected region 330 could be tasked. Alternatively, in another envisioned embodiment a partitioned application node could be chosen according to the most specific geographic coverage. Other possible tie-breaking algorithms will be evident to those of ordinary skill in the art.

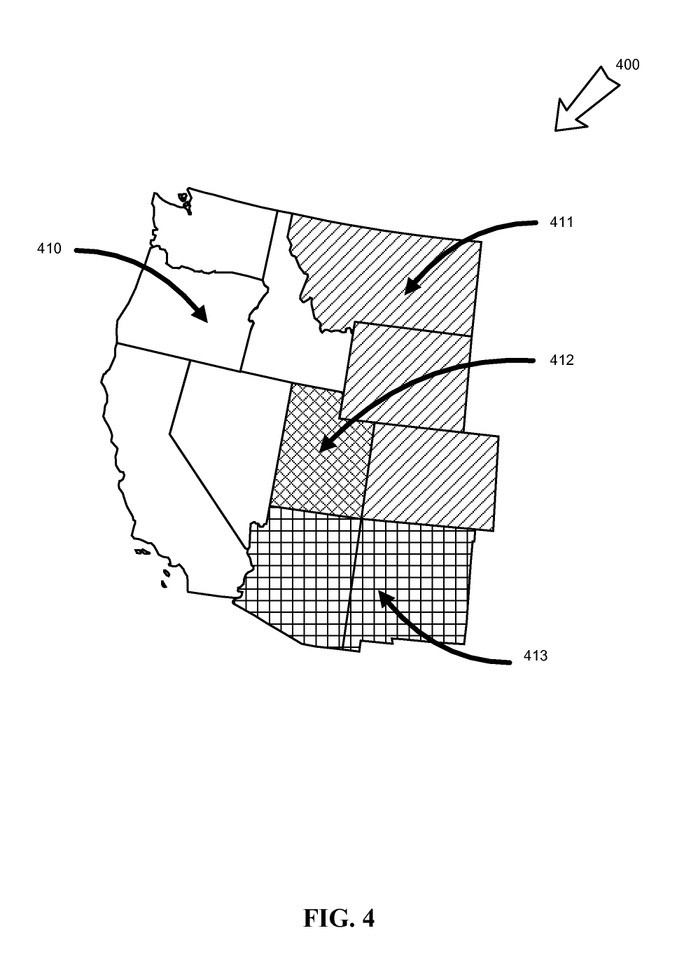

FIG. 4 illustrates one preferred implementation of the example geographic partitioning strategy described in 300, wherein responsibility for application processing is subdivided according to a state border geometric feature class. In the clarifying example shown a western region containing the states of California, Nevada, Oregon, Washington and Idaho is declared as a single geographic area of responsibility 410 and application processing requests could be routed or forwarded to a corresponding partitioned application node having responsibility over this region according to the described process 200. Other declared geographic areas of responsibility are a region containing Montana, Wyoming, Colorado, Utah 411 and a region containing Utah, Arizona, and New Mexico 413. In the example 400 the state of Utah 412 is contained within two different assignment geometries and, correspondingly, two partitioned application nodes may be presumed responsible for the Utah geographic region according to the described process 200. If only one partitioned application node is desired to handle a given application processing requests a tie breaking strategy may be implemented, such as, for example, intersection, containment, most specific geography, round-robin, server load, etc.

Unless specifically stated otherwise it is appreciated that throughout this document terms such as “processing,” “computing,” “calculating,” “determining,” or the like refer to the action and/or processes of a computer or computing system, or similar electronic computing device.

Embodiments of the present invention may include apparatuses and/or devices for performing the operations herein. An apparatus may be specially constructed for the desired purposes, or it may comprise a general purpose device selectively activated or reconfigured by a program stored in the device.

Embodiments of the invention may be implemented in one or a combination of hardware, firmware, and software. Embodiments of the invention may also be implemented as instructions stored on a machine-readable medium, which may be read and executed by a computing platform to perform the operations described herein. A machine-readable medium may include any mechanism for storing or transmitting information in a form readable by a machine (e.g., a computer). For example, an exemplary machine-readable storage medium may include, e.g., but not limited to, read only memory (ROM); random access memory (RAM); magnetic disk storage media; optical storage media; magneto-optical storage media; flash memory devices; etc.

### Summary

It is now appreciated how an application may be partitioned across one or more processing nodes according to a strategy that defines geographic areas of responsibility to the partitioned application processing node. It is also now appreciated how the same geographic distribution strategy may be further employed to extend application functionality by varying the specific configuration of the various application nodes, as was described in the sales tax calculator example.

Although a variety of examples and other information was used to explain aspects within the scope of the appended claims no limitation of the claims should be implied based on particular features or arrangements in such examples as one of ordinary skill would be able to use these examples to derive a wide variety of implementations. Further, and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

1. A computer-implemented method for distributed application processing across a plurality of nodes, the method comprising:
a. registering the geographic area of responsibility for a application node within a database; and
b. receiving a application request; and
c. identifying one or more responsible application nodes based upon location information learned from the application request; where
d. the one or more responsible application nodes is identified according to a geometric calculation that incorporates each specific application node's geographic area of responsibility information

2. The method of claim 1, wherein the configuration of each specific application node is varied according to its geographic area of responsibility.

3. The method of claim 1, wherein the request is forwarded to at least one of the identified one or more responsible application nodes for immediate processing.

4. The method of claim 3, wherein a tie-breaking algorithm is employed to select exactly one of the identified one or more responsible application nodes.

5. The method of claim 1, wherein the request is routed to at least one of the identified one or more responsible application nodes; and
a. processing the request on each of the one or more responsible application nodes;
b. receiving a intermediate response from the one or more responsible application nodes by the primary receiving node;
c. forwarding each intermediate response to the querying party by the primary application node without modifying the intermediate response information.

6. The method of claim 5, wherein a tie-breaking algorithm is employed to select exactly one of the identified one or more responsible application nodes.

7. The method of claim 1, wherein the request is routed to at least one of the identified one or more responsible application nodes; and
a. processing the request on each of the one or more responsible application nodes;
b. receiving a intermediate response from the one or more responsible application nodes by the primary application node;
c. collecting, assembling or processing the information within various intermediate responses by the first primary application node into a single response;
d. forwarding the single response to the querying party by the primary application node.

8. The method of claim 7, wherein a tie-breaking algorithm is employed to select exactly one of the identified one or more responsible application nodes.

9. A system to distribute a computer application, the system comprising:
a. a partitioning assignments database storing various geographic partitioning assignment information; and
b. a plurality of processing nodes collectively configured with various instances and optionally with various configurations of an application; and
c. a designated primary application node configured to receive incoming application processing requests, to establish location information from each application processing request, and to query a partitioning assignments database to identify one or more other responsible partitioned application nodes; and also configured
i. if a responsible partitioned application node is discovered by the primary application node to incorporate that responsible partitioned application node's functionality into its own by either:
1. routing the application request to the responsible partitioned application node, receiving a intermediate response from the responsible partitioned application node, and either forwarding or processing the intermediate response; or
2. forwarding the application processing request to the responsible partitioned application node; and either forwarding or processing the intermediate response; and
ii. if more than one responsible partitioned application node is identified optionally implementing a tie-breaking algorithm to select exactly one of the responsible partitioned application nodes.

10. The system of claim 9, wherein the primary and various responsible partitioned application nodes and, optionally, the partitioning assignments database may be executed on a single computer system.

11. The system of claim 9, wherein the primary and various responsible partitioned application nodes may be variably configured according to their respective geographic areas of responsibility.

12. A non-transitory computer-readable medium comprising processor executable instructions that, when executed by a computer included in a computing device, cause the computing device to carry out steps that include:
a. receiving a application processing request from a requesting entity;
b. examining the received application processing request and determining a location information;
c. incorporating the location information into a database query and receiving from the queried database a response that identifies one or more responsible partitioned application nodes;
d. routing or forwarding the application processing request to one or more of the identified responsible partitioned application nodes;
e. optionally receiving one or more intermediate responses from the one or more partitioned application nodes;
f. optionally forwarding the one or more intermediate responses to the requesting entity;
g. optionally receiving and processing the one or more intermediate responses into a single final response and then forwarding the final response to the requesting entity.
